(19) United States
(12) Patent Application Publication
(10) Pub. No.: US 2021/0249654 A1
(43) Pub. Date: Aug. 12, 2021

(54) FAST CHARGE FEOF CATHODE FOR LITHIUM ION BATTERIES

(71) Applicants: Yadong LIU, Indianapolis, IN (US); Fan YANG, Carmel, IN (US); Indiana University Research and Technology Corporation, Indianapolis, IN (US)

(72) Inventors: Jian Xie, Zionsville, IN (US); Yadong Liu, Zionsville, IN (US)

(21) Appl. No.: 17/251,506

(22) PCT Filed: Jun. 13, 2019
(86) PCT No.: PCT/US2019/036954

§ 371 Date: Dec. 11, 2020

Related U.S. Application Data
(60) Provisional application No. 62/684,252, filed on Jun. 13, 2018.

(51) Int. Cl. H01M 4/36; H01M 4/133; H01M 10/0525; H01M 4/587; H01M 4/136; H01M 4/58

(52) U.S. Cl. CPC H01M 4/366; H01M 4/133; H01M 10/0525; H01M 2004/027; H01M 4/136; H01M 4/582; H01M 4/587

(57) ABSTRACT

A cathode material including a nanostructured graphene-incorporated iron oxyfluoride-based (FeOF) composite material (FeOF/G). The FeOF/G composite cathode material may have superfast charging rates, high specific capacity/energy, and enhanced cycle life.

### CROSS REFERENCE TO RELATED APPLICATION

This application claims priority to U.S. Provisional Patent Application Ser. No. 62/684,252, filed Jun. 13, 2018, the disclosure of which is hereby expressly incorporated by reference herein in its entirety.

### FIELD OF THE DISCLOSURE

The present disclosure relates to the field of electromechanical engineering, and more specifically, to rapidly rechargeable battery systems for electric vehicles.

### BACKGROUND OF THE DISCLOSURE

The transportation sector consumes 70% of U.S. petroleum, but the average thermal efficiency of internal combustion engines (ICEs) is only about 30%. Electrification of transportation can effectively increase the thermal efficiency of energy conversion, reduce the dependency on imported foreign oils, and decrease emissions. Fuel cell (FC) powered and battery powered electric vehicles (EVs) are two major technologies for electrification of transportation (EOT). Although FCEVs have high energy efficiency and emit almost no pollution, the cost of FC systems has so far severely hindered market penetration. Therefore, in the foreseeable future the plug-in battery electric vehicle is still an economically viable and environmentally friendly approach for EOT before the inevitable massive market adoption of FCEVs.

The current technology for plug-in battery powered vehicles revolves around lithium ion batteries (LIBs). Unfortunately, the slow recharging time for LIBs is one of the major market barriers to massive market adoption for both freight and passenger transportation. LIBs generally need hours of recharging to reach a fully charged state, while ICEs take only minutes to refuel. Hence, batteries with the capability of superfast charging are urgently needed for the plug-in EVs, and the successful development of this technology will certainly lead to a surge in the massive market adoption of EVs.

Charging techniques can improve the fast charging performance of LIBs, but only to a certain degree, and improper high-rate charging runs the risk of damaging the electrode materials. Hence, there is a need for the development of battery materials with the capability of superfast charging. The present novel technology addresses this need.

### SUMMARY

The present disclosure provides a cathode material including a nanostructured graphene-incorporated iron oxyfluoride-based (FeOF) composite material (FeOF/G). The FeOF/G composite cathode material may have superfast charging rates, high specific capacity/energy, and enhanced cycle life.

According to an embodiment of the present disclosure, a lithium ion cell is disclosed including a cathode with a graphene-incorporated iron oxyfluoride composite (FeOF/G) and an anode, wherein the cell has a specific energy of at least 180 Wh/kg under a charge rate of at least 6 C. The cell may have a charging time of 10 minutes or less.

In certain embodiments, the cell has a specific energy of at least 180 Wh/kg under a charge rate of at least 100 C. The cell may have a charging time of 1 minute or less.

In certain embodiments, the cell has a specific energy of at least 180 Wh/kg under a charge rate of 500 C. The cell may have a charging time of 30 seconds or less.

According to another embodiment of the present disclosure, a lithium ion cell is disclosed including an electrolyte, a cathode with a graphene-incorporated iron oxyfluoride composite (FeOF/G), and an anode comprising a lithiated graphite.

In certain embodiments, the electrolyte includes a solvent having an electrochemical window of at least 6.0 V.

In certain embodiments, the FeOF/G composite comprises a plurality of graphene sheets and FeOF nanoparticles distributed over the graphene sheets.

In certain embodiments, the FeOF/G composite comprises a plurality of graphene sheets and FeOF nanoparticles positioned between adjacent graphene sheets.

In certain embodiments, the cell has a charge rate of at least 6 C or at least 50 C.

In certain embodiments, the cell has a cycle life of at least 500 cycles.

In certain embodiments, the cell has a specific energy of at least 180 Wh/kg.

According to yet another embodiment of the present disclosure, a cathode is disclosed including at least one graphene sheet and a layer of iron oxyfluoride (FeOF) nanoparticles evenly distributed over the graphene sheet to define a composite material.

In certain embodiments, the at least one graphene sheet is at least two parallel graphene sheets, the layer of FeOF nanoparticles being positioned between the at least two parallel graphene sheets.

In certain embodiments, the at least one graphene sheet is functionalized to adhere the FeOF nanoparticles thereto.

In certain embodiments, the cathode has a specific capacity from 300 to 600 mAh/g with a charging rate of 6 C and a discharging rate of 0.2 C. The specific capacity may be 491 mAh/g when the charging rate is 6 C. The specific capacity may be 309 mAh/g when the charging rate is 500 C.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 is a schematic illustration of a battery cell of the present disclosure including an anode and a cathode with a nanostructured graphene-incorporated iron oxyfluoride-based (FeOF) composite material (FeOF/G);

FIG. 2 schematically illustrates the synthesis of the FeOF/G composite material;

FIG. 3 is a graphical representation of the electronic structure of graphene;

FIG. 4 includes: scanning electron microscope (SEM) photomicrographs of (a) FeOF/G composite and (c) FeOF; transmission electron microscope (TEM) images of (b) FeOF/G composite and (d) FeOF; and diffraction pattern images of (e) FeOF/G composite and (f) FeOF;

FIG. 5 is a graphical representation comparing mercury intrusion porosimetry data for FeOF/G composite materials and FeOF;

FIG. 6 is a graphical representation of charge/discharge curves for (a) FeOF/G-Li metal cells, (b) FeOF/G-lithiated graphite cells, and (c) FeOF/G- lithium titanate (LTO) cells;

FIG. 7 is a graphical representation of charge/discharge curves for FeOF and a FeOF/G composite;

FIG. 8 is a graphical representation of the valence change in FeOF during charge/discharge cycles for FeOF and FeOF/G composite materials, specifically (a) FeOF during initial discharge, (b) FeOF during initial charge, (c) FeOF/G during initial discharge, (d) FeOF/G during initial charge, (e) FeOF during discharge after 10 cycles, (f) FeOF during charge after 10 cycles, (g) FeOF/G during discharge after 10 cycles, and (h) FeOF/G during charge after 10 cycles;

FIG. 9 illustrates TEM diffraction patterns of (a) FeOF and (b) FeOF/G composite;

FIG. 10 illustrates electron energy loss spectroscopy (EELS) images of FeOF/G particles after first lithiaton and delithiation cycles;

FIG. 11 is a schematic illustration of the rutile core-shell structure of FeOF in (a) a pristine rutile state, (b) a lithiated state, and (c) a delithiated state.

FIG. 12 is a schematic illustration of (a, b) the rocksalt crystal structure and (c, d) the rutile crystal structure of FeOF;

FIG. 13 is a schematic illustration of the synthesis of polyaniline (PANI) coated FeOF/G composite; and

FIG. 14 is a graphical representation of cycle life data for two different electrolytes.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

Before the present methods, implementations and systems are disclosed and described, it is to be understood that this invention is not limited to specific methods, specific components, implementation, or to particular compositions, and as such may, of course, vary. It is also to be understood that the terminology used herein is for the purpose of describing particular implementations only and is not intended to be limiting. Neither are explanations that have been provided to assist in understanding the disclosure meant to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance may or may not occur, and that the description includes instances where said event or circumstance occurs and instances where it does not.

Unless otherwise defined, the technical, scientific, and medical terminology used herein has the same meaning as understood by those skilled in the art. However, for the purposes of establishing support for various terms that are used in the present application, the following technical comments, definitions, and review are provided for reference.

### 1. Introduction to Super-Fast Charging

The Department of Energy (DOE) describes superfast charging as ≥6 C charging, 180 Wh/kg and 500 cycles under a 6 C charge and 1 C discharge protocol. Several crucial factors determine the superfast charging performance of a LIB cell: (i) diffusion of lithium (Li⁺) ions in the anode and cathode host materials, (ii) charge transfer of electrons in the anode and cathode, and (iii) a wide electrochemical window of the electrolyte (i.e. high-voltage electrolyte). Superfast charging requires fast (de)lithiation of the electrode materials, which, in turn, needs rapid Li⁺ ion diffusion within the solid electrode (i.e. high diffusion coefficient, D_{Li+,solid}) and the fast phase change of the host materials in combination with a high electronic conductivity of the electrode materials to supply enough electrons (e⁻). For most intercalation compounds used in LIBs as anodes and cathodes, the diffusion of Li⁺ ion is quite slow (e.g. D_{Li+}, LiFePO4=1.8×10-14 cm2/s). Hence, a large overpotential drives Li⁺ ion diffusion in both electrodes during superfast charging. Consequently, the cell voltage becomes unacceptably high, which could go beyond the electrochemical window of the electrolyte.

Current superfast charging materials mainly focus on (1) the intercalation compounds and (2) polymer based electrode materials. Such materials are described herein and summarized in Table 1 below. Since most intercalation compounds with layered (e.g. LiCoO2), spinel (e.g. LiMn2O4), or olivine (e.g. LiFePO4) structures have quite low Li⁺ ion diffusion coefficients (i.e. D_{Li+, LiFePO4}=1.8×10-14 cm²/s, D_{Li+, LiCoO2}=10⁻¹⁰-10⁻⁸ cm²/s, D_{Li+, LiMn2O4}=10⁻¹¹-10⁻⁹ cm²/s), the major approach is to reduce the particle size to shorten the diffusion length, such as using nanoparticles (e.g. LiMn₂O₄, 10 C, 70 mAh/g), nanobelts and nanoribbons. Increasing the surface area of the electrode materials is another approach for fast charging which can effectively reduce the current density, consequently reducing the overpotential by providing a large surface area for Li⁺ access (e.g. mesoporous LiFePO₄, 10 C, 120 mAh/g). Cathode materials such as metal oxides, metal fluorides, and metal oxyfluorides have very low electronic conductivity, which is another factor hindering the fast charging. The solution is coating a thin carbon layer, incorporating graphene sheets to form a nanocomposite (i.e. 20 C, 80 mAh/g), using a graphene 3-D network as the current collector (i.e. 30 C, LiFePO₄, 120 mAh/g,), and chemically grafting polymer to the surface of electrode materials, with subsequent pyrolyzing to form a uniform carbon coating layer to improve the conductivity. Polymer-based electrodes include polymer-bound pyrene-4,5,9,10-tetraone ((i.e. 30 C, 210 mAh/g), poly-(anthraquinonyl sulfide) and polyimide (i.e. 20 C, 80 mAh/g), and polypyrrole (i.e. 600 mA/cm2, 38-50 mAh/g). Most of these materials are monovalent and impart some improvement on the charging rate, but the specific capacity/energy remains quite low. Measures have been explored to use (1) multivalent compounds and (2) high-voltage cathode materials. Porous Li₃V₂(PO₄)₃/C yields up to a 60 C charging rate with 88 mAh/g while nanobelt Li₃V₂(PO₄)₃ and VO₂-Graphene ribbons show 8 C and 110 mAh/g and 190 C, 200 mAh/g, respectively. High-voltage cathode materials have an inherently high specific energy, Li(Ni_{0.5}Mn_{0.5})O₂ (i.e. 6 C, 170 mAh/g), Mn_{1/3}Fe_{1/3})_{O2} (i.e. 40 C, 110 mAh/g), Li(Ni_{0.75}Co_{0.11}Mn_{0.14})O2 (i.e. 20 C, 90 mAh/g), Li(Ni_{0.5}Mn_{1.5})O₄ (i.e. 5 C, 60 mAh/g), and Li(Ni_{1/3}Co_{1/3}Mn_{1/3})O₂ (i.e. 100 C, 123 mAh/g). All current approaches can achieve quite high charging rates; however, the specific capacities are quite low, as shown in Table 1, which makes them hard to meet the DOE target of a 6 C rate, 180 Wh/kg.

TABLE 1
Summary of different work on superfast charging

| | Specific | |
|---|---|---|
| | Capacity | |
| Materials | (mAh/g) | Cycle Life |
| CuHCF | 55.2 (8.3 C) | 2700 (17 C) |
| | 52.4 (17 C) | |
| | 47.0 (42 C) | |
| | 40.1 (83 C) | |
| VO₂/Graphene | 304 (12 C) | >1000 (190 C) |
| | 275 (28 C) | |
| | 203 (84 C) | |
| | 181 (190 C) | |
| LTO/Graphene | 162 (30 C) | >500 (30 C) |
| | 155 (50 C) | |
| | 144 (100 C) | |
| | 133 (200 C) | |
| Li₃V₂(PO₄)₃ nanobelts | 110 (8 C) | N/A |
| LiFePO₄/C | 127 (5 C) | >1000 (10 C) |
| | 120 (10 C) | |
| Li₃V₂(PO₄)₃/C | 154 (10 C) | 240 (10 C) |
| | 138 (20 C) | 30 (100 C) |
| | 130 (40 C) | |
| | 104 (100 C) | |
| Cellulose/PPy | 25.6 (5 C) | >100 (10 C) |
| | 24.0 (10 C) | |
| LiFe_{0.9}P_{0.95}O_{4-d} | 163 (10 C) | >50 (20 C) |
| | 153 (20 C) | >50 (60 C) |
| | 141 (40 C) | |
| | 131 (50 C) | |
| Carbon-Coated Single-Crystal | 113 (10 C) | 750 (20 C) |
| LiMn₂O₄ Nanoparticle Clusters | 110 (20 C) | |
| | 98 (50 C) | |
| | 54 (100 C) | |
| Li(Ni_{0.5}Mn_{0.5})O₂ | 178 (6 C) | 24 (1C) |
| LiMn₂O₄ and Carbon Nanocomposites | 100 (10 C) | >70 |
| (56% Carbon Black) | 96 (20 C) | |
| | 94 (50 C) | |
| LiNi_{0.75}Co_{0.11}Mn_{0.14}O₂ Particles | 125 (7 C) | 120 (12 C) |
| Consisting of V₂O₅ and LiₓV₂O₅ | 113 (12 C) | |
| Coating and a Li_{δ}NiCo_{0.11}Mn_{0.14}VzO₂ | 92 (20 C) | |
| Layer LiMn₂₋ₓNiₓO₄ | 123 (10 C) | N/A |
| | 116 (18 C) | |
| Li(Mn_{1/3}Ni_{1/3}Fe_{1/3})O₂-Polyaniline | 127 (5 C) | 40 (5C) |
| Hybrids | 114 (30 C) | |
| | 110 (40 C) | |
| Nanoparticled Li(Ni_{1/3}Co_{1/3}Mn_{1/3})O₂ | 130 (8C) | 22 (8 C) |
| | 128 (30 C) | |
| | 120 (60 C) | |
| Nanoporous LiNi_{1/3}Co_{1/3}Mn_{1/3}O₂ | 138 (7.5 C) | >50 (3C) |
| | 124 (12 C) | |
| | 120 (20 C) | |
| | 99 (50 C) | |
| Polymer-Bound Pyrene-4,5,9,10-tetraone | 139 (10 C) | 500 (1C) |
| | 228 (20 C) | |
| | 224 (30 C) | |
| Polymer (PAQS)-Graphene | 146 (10 C) | N/A |
| Nanocomposites | 135 (20 C) | |
| | 121 (50 C) | |
| | 100 (100 C) | |
| | 58 (200 C) | |
| FeOF/G (See Table 3 below) | 492 (6 C) | 207 (1 C) |
| | 465 (10 C) | 49 (6 C) |
| | 420 (20 C) | |
| | 351 (60 C) | |
| | 342 (100 C) | |
| | 317 (200 C) | |
| | 310 (500 C) | |

As mentioned above, most current approaches focus on intercalation compounds as candidates, but the specific capacity/energy of these materials is quite low due to (1) low materials utilization caused by slow Li⁺ diffusion, (2) low electronic conductivity, and (3) low Li⁺ storage capacity associated with monovalence characteristics and cannot be compensated for, even by using high-voltage materials. Hence, to meet the DOE targets for superfast charging of at least 6 C charging with at least 180 Wh/kg, 500 cycles using 6 C charge/1 C discharge protocol, the major challenges for developing superfast charging battery electrode materials are achieving (enabling) (1) a high Li⁺ diffusion coefficient, (2) high e⁻ conductivity, and (3) high specific capacity/energy.

### 2. FeOF/G Composite Cathode Materials

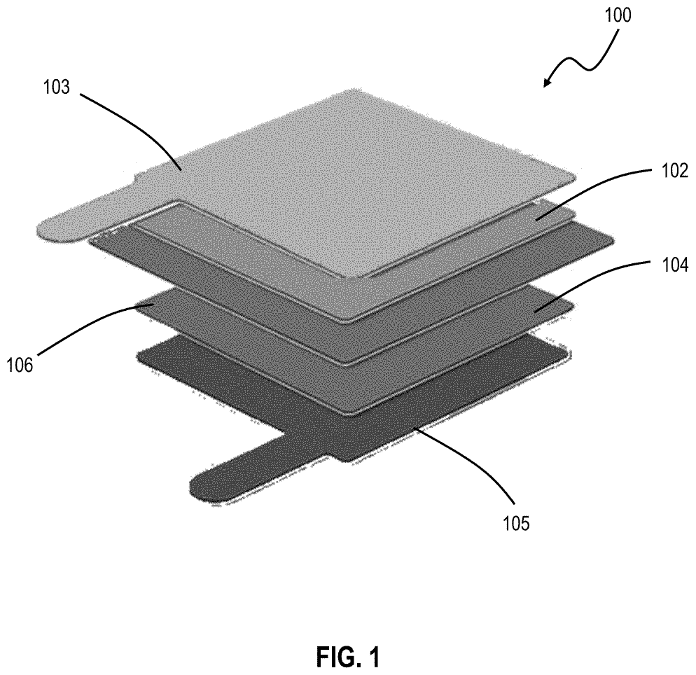

FIG. 1 provides a superfast charging battery 100, specifically a LIB, including an anode 102 coupled to an anode current collector 103, a cathode 104 coupled to a cathode current collector 105, and an electrolyte-filled separator 106. The illustrative battery 100 is a pouch cell (e.g., a 2-Ah pouch cell), but the battery 100 may also be a cylindrical cell, a coin cell, or a prismatic cell, for example. The battery 100 may be configured for use in a portable electronic device, an electric vehicle, an energy storage device, or other electronic devices.

The anode 102 may comprise a lithiated material (e.g., lithiated graphite) or another suitable material. In operating the anode 102, attention should be paid to the control of the state of charge (SOC) to prevent Li plating because, the lower the SOC, the higher the anode potential, resulting in less Li plating.

The electrolyte 106 may comprise a high-voltage electrolyte that accommodates a high cell voltage resulting from superfast charging. The solvent may have a wide electrochemical window (e.g., ≥6.0 V) and Li⁺ conductivity (e.g., ≥10⁻⁴ S/cm). The electrolyte 106 may also include soluble lithium salts (e.g. LiPF₆, LiTFSI, LiFSI, etc.). One exemplary electrolyte comprises LiPF₆ salts in a fluoroethylene carbonate (FEC)/bis(2,2,2-trifluoroethyl) carbonate (HFDEC) solvent. Other potential solvents include other fluorinated carbonate solvents, sulfone-based solvents, ionic liquid-based solvents, and nitrile-based solvents, for example.

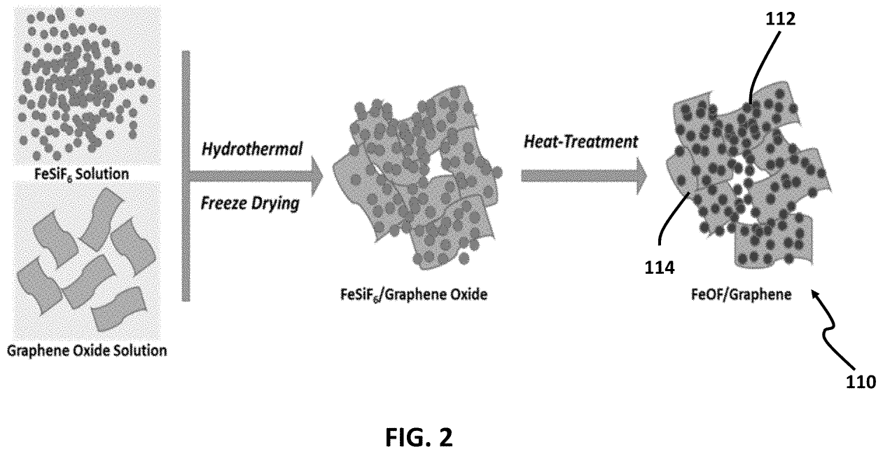

FIG. 2 provides an improved composite cathode material 110 for cathode 104 of battery 100 (FIG. 1) comprising a nanostructured graphene-incorporated iron oxyfluoride-based (FeOF) composite material (FeOF/G). More specifically, the FeOF/G composite cathode material 110 includes high surface area FeOF nanoparticles 112 finely dispersed over a conductive matrix of graphene sheets 114. The graphene sheets 114 may be layered to function like a cage that holds the FeOF nanoparticles 112 and prevents them from escaping. The FeOF/G composite cathode material 110 may have a high surface area and e⁻ conductivity and improved stability from FeOF nanoparticles 112 anchoring on graphene sheets 114. The graphene sheets 114 may account for about 1-10 wt. %, more specifically about 2-8 wt. %, of the total FeOF/G composite cathode material 110, which may resist re-stacking.

FeOF alone may have theoretical specific capacities of 885 mAh/g (3-electron process) and 590 mAh/g (2-electron process) and specific energies of 2938 Wh/kg (3-electron process) and 1958 Wh/kg (2-electron process). However, FeOF also has low e⁻ conductivity and a short cycle life due to the loss of Fe²⁺, metallic FeO nanoparticles, and Li⁺ ions in the formed LiF₃O. The incorporated graphene sheets 114 may improve the electrical conductivity of the FeOF/G composite cathode material 110 compared to the FeOF nanoparticles 112 alone. Additionally, the graphene sheets 114 may provide a structural matrix to anchor and stabilize the FeOF nanoparticles 112 and reduce volume change stress during charge/discharge cycling.

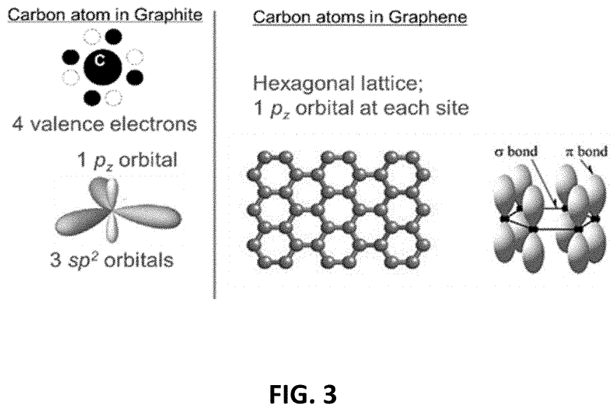

As shown in FIG. 3, each graphene sheet 114 may be a single atomic layer of sp²-bonded carbon atoms arranged in a honeycomb crystal structure and can be viewed as an individual atomic plane of the graphite structure. In graphene, each carbon atom uses 3 of its 4-valence band (2s, 2p) electrons (which occupy the 3 sp² orbits) to form 3 covalent bonds with the neighboring carbon atoms in the same plane. Each carbon atom in the graphene contributes its fourth lone electron (occupying the p_{z} orbit) to form a delocalized electron system, a long-range n-conjugation system shared by all carbon atoms in the graphene plane. Such a long-range π-conjugation in graphene yields extraordinary electrical (i.e. extremely high electric conductivity, 6.29×10⁷ S/cm), mechanical (i.e. fracture strength˜130 GPa), and thermal properties (i.e. 3000 W/m-K in plane). According to an exemplary embodiment of the present disclosure, the FeOF/G composite cathode material 110 may comprise about 1 wt. % to about 10 wt. % graphene, more specifically about 1 wt. % to about 5 wt. % graphene, more specifically about 2 wt. % graphene. The graphene content should be sufficiently low to maintain the graphene as single sheets and avoid re-stacking. Additional information regarding the incorporation of graphene sheets 114 is disclosed in U.S. Publication No. 2015/0380732, the disclosure of which is expressly incorporated herein by reference in its entirety.

Graphene can be prepared using the chemical or thermal reduction of graphene oxide (GO), which is a layered stack of oxidized graphene sheets with different functional groups. Thus, GO can be easily dispersed in the form of single sheet in water at low concentrations. The cost of GO is very low (e.g. estimated $10-20/kg from chemical oxidation of nature graphite method), hence the incorporation of graphene into the FeOF nanoparticles 112 should not result in significant additional cost since only very small amount of graphene is used. The key is to control the low concentration of GO to avoid the restacking of the GO sheets, which leads to the diminishing of the unique properties of graphene.

The incorporation of graphene sheets 114 turns the simple FeOF nanoparticles 112 into a functional material with the following properties: (A) superfast charging rates; (B) high specific capacity/energy, and (C) enhanced cycle life. Thus, the FeOF/G composite cathode material 110 may achieve (1) a high Li⁺ diffusion coefficient, (2) high e⁻ conductivity, and (3) high specific capacity/energy for meeting the DOE targets of superfast charging, specifically ≥6 C charging, 180 Wh/kg and 500 cycles under a 6 C charge and 1 C discharge protocol. The FeOF/G composite cathode material 110 may have the following properties: (1) superfast charging capability from 6 to 500 C or more (e.g., 500 C, 7.2 s), (2) high specific capacity from 300 to 600 mAh/g or more (e.g., 500 C, 7.2s, 309.85 mAh/g), (3) high specific energy from 200 to 600 Wh/kg or more (e.g., FeOF/G/Graphite 2-Ah cell: 6 C, 10 min. 476 Wh/kg; 100 C, 36s, 238 Wh/kg), (4) low cost (e.g., $3.65/kg), and (5) enhanced cycle life of 250 to 500 cycles or more. Depending on the charge rate, the battery 100 may charge in 10 minutes, 5 minutes, 1 minute, 30 seconds, 10 seconds, 7 seconds, or less. In certain embodiments, the FeOF/G battery 100 may have less than 10 minutes (6 C) of superfast charging, specific energy of 1047 Wh/kg (FeOF only), and 476 Wh/kg (FeOF/G/Graphite cell, active materials only) at C/3, respectively, and 500 cycles under the protocol of 6 C charge and 1 C discharge to exceed the DOE targets. In particular examples, the FeOF/G battery 100 may exhibit even higher charging rates and faster charging times, e.g. 50 C (1.2 min.) or 100 C (36 s) or 500 C (7.2 s) with a corresponding specific energy of 617, 582 and 526 Wh/kg, respectively, and at least 500 cycles.

As the Li⁺ diffusion coefficients in intercalation compounds can't be improved to the level for superfast charging, the FeOF/G composite cathode material 110 utilizes the conversion reaction of the (de)lithiation of FeOF/G, which is a surface reaction, and the rate of (de)lithiation is limited only by the Li⁺ diffusion within the liquid electrolyte. The mechanism of FeOF (de)lithiation accommodates the Fe valence change, morphology, and structural change of FeOF during cycling. The synergy of the nanostructured FeOF/G composite cathode material 110, the functionalization, the mechanism, and the high-voltage electrolyte may yield the battery 100 that achieves superfast charging targets, especially for automotive applications.

### Synthesis Method

An exemplary solution-based solvothermal method is shown in FIG. 2 for synthesizing the FeOF/G composite cathode material 110. First, a FeOF precursor solution, specifically FeSiF₆.6H₂O, is prepared. In one embodiment, a high-purity iron metal powder is treated with aqueous hexafluorosilicic acid (H₂SiF₆) solution, stirred at a temperature of about 40-55° C., and filtered to obtain the FeSiF₆ solution. Next, the FeOF precursor solution is mixed with a dilute graphene oxide (GO) solution. The graphene oxide may be present in the mixture at a desired weight percentage of about 0.1-70 wt. %. The graphene oxide may have desired functional groups, as described in Section III below. The mixture is heated to a suitable temperature of about 120° C. to form FeF₂ according to Reaction (1) below, and then the FeF₂ is further heated to a temperature of about 200-240° C. for 5-20 hours under O₂ gas flow to form FeOF according to Reaction (2) below. The solvent for the solvothermal method can be, but is not limit to, water, methanol, ethanol, N-Methyl-2-pyrrolidone (NMP), benzyl alcohol, and the like, and/or mixtures thereof.

FeSiF₆.6H₂O→FeF₂+SiF_{4(gas)}+6H₂O_{(gas)} (1)

FeF₂+O_{2(gas)}→FeOF (2)

The FeOF product may then be freeze-dried/spray-dried and heat-treated in a tube furnace with temperature of about 200-350° C. for about 1-12 hours to reduce the GO to graphene. The various method steps, including the temperatures, times, concentration of precursor FeSiF₆, and concentration of graphene oxide, may be controlled and optimized to obtain FeOF nanoparticles with small diameter.

### Improved FeOF Dispersion and Particle Size

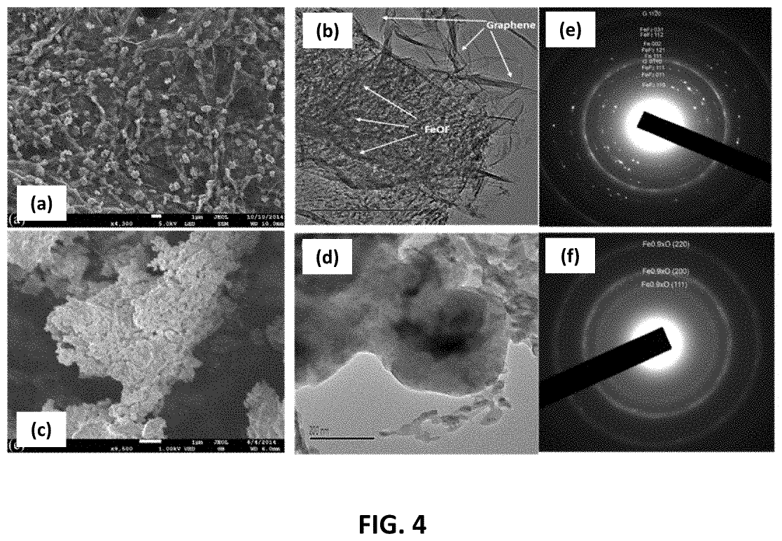

As shown in the SEM and TEM images of FIG. 4, the FeOF/G composite material showed improved FeOF morphology. For the FeOF/G composite material (FIGS. 4a and 4c), small, typically spherical or spheroid, FeOF particles (around 1 μm) are uniformly formed over the graphene sheet and these particles are made of FeOF nanorods (dia.=3 nm and length=20 nm). For the blank FeOF (FIGS. 4b and 4d), the FeOF particles are big chunks (20-60 μm) with some small particles on the surface (300-500 nm). The diffraction patterns of these materials (FIGS. 4e and 4f) clearly show that the synthesized materials are indeed FeOF. These results show that the graphene nano-sheets serve as substrates to stabilize the structure of FeOF and form a framework to stabilize the Fe clusters through bonding them to their original sites without migration. Thus, the FeOF/G composite can keep the (de)lithiation reaction reversible during discharge and charge process.

### Improved Pore Structure

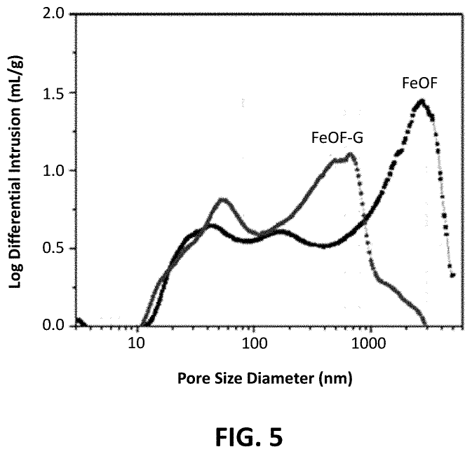

As shown in FIG. 5 and Table 2 below, incorporation of graphene sheets also improves the pore structure. The improved pore structure of FeOF/G arises from the spaces between adjacent FeOF nanoparticles 112 and the spaces between adjacent graphene sheets 114 (FIG. 2). These spaces provide channels within the FeOF/G for electrolyte penetration, facilitating fast Li⁺ ion transport, and directly improving the fast charging.

TABLE 2
Porosity

| Material | Pore Volume (mL/g) | Pore Ranges (nm) |
|---|---|---|
| FeOF | 0.5734 | 10-900 |
| | 1.0109 | 900-5000 |
| FeOF/G | 0.8921 | 10-900 |
| | 0.1993 | 900-5000 |

### Superior Superfast Charging Capability with High Specific Capacity/Energy

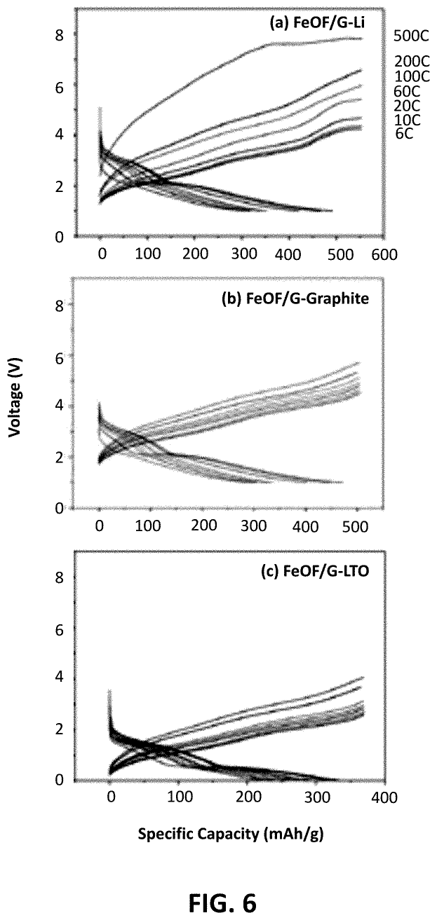

As shown in FIG. 6 and Table 3 below, the FeOF/G nanocomposite material shows excellent superfast charging performance. For example, the FeOF/G nanocomposite material can be charged at 6 C, then, discharged at 0.2 C, delivered 491 mAh/g, 876 Wh/kg Surprisingly, this FeOF/G nanocomposite material can be charged to up to 500 C but still delivers 309 mAh/g, 526.7 Wh/kg at 0.2 C discharge. Such superior superfast charging performance arises because, unlike the intercalation compounds where the charging rate is limited by the Li⁺ ion diffusion within these solids (e.g. D_{Li+, LiFePO4}=1.8×10⁻¹⁴ cm²/s), the charging of the conversion FeOF cell is a surface reaction (with finely dispersed particles 112) and, hence, the charging rate is limited only by the Li⁺ ion diffusion in the liquid electrolyte (D_{Li+, Org}=2.3×10⁻⁶ cm²/s). In contrast, the blank FeOF did not exhibit any fast charging performance. In addition to the conversion reaction, this superior superfast charging performance is also the combined effect of its nanostructure (which provides high surface area and facile access to Li⁺ ions, facilitating the fast Li⁺ ion transport within the FeOF/G layers) and graphene sheets (which profoundly improve the e⁻ conductivity of the composite).

TABLE 3
Summary of superfast charging of FeOF/G at different rates and discharging at 0.2 C

| | | | | | | | | End Charging Voltage | | | Specific Energy | | |
|---|---|---|---|---|---|---|---|---|---|---|---|---|---|
| | | | | Specific | Capacity | Specific | Voltage | (V) | | | (Wh/kg) | | |
| | | | C- | Capacity | Retention | Energy | Peak | FeOF/ | FeOF/G- | FeOF/ | FeOF/ | FeOF/G- | FeOF/ |
| Test | Time | | Rate | (mAh/g) | (%) | (Wh/kg) | (V) | G-Li | Graphite | G-LTO | G-Li | Graphite | G-LTO |
| 1 | 12 | min | 5 | 515 | 89 | 876 | 4.12 | 4.32 | 4.26 | 2.48 | 453 | 443 | 285 |
| 2 | 10 | min | 6 | 492 | 85 | 836 | 4.27 | 4.56 | 4.48 | 2.57 | 432 | 421 | 271 |
| 3 | 6 | min | 10 | 465 | 80 | 791 | 4.37 | 4.79 | 4.66 | 2.71 | 409 | 404 | 257 |
| 4 | 3 | min | 20 | 420 | 72 | 713 | 4.69 | 4.91 | 4.82 | 2.79 | 369 | 370 | 232 |
| 5 | 1 | min | 60 | 351 | 61 | 597 | 5.42 | 5.42 | 4.96 | 2.98 | 309 | 312 | 194 |
| 6 | 36 | s | 100 | 342 | 59 | 582 | 5.98 | 5.98 | 5.12 | 3.17 | 301 | 308 | 189 |
| 7 | 18 | s | 200 | 318 | 55 | 540 | 6.58 | 6.58 | 5.33 | 3.68 | 279 | 289 | 175 |
| 8 | 7.2 | s | 500 | 310 | 53 | 527 | 7.84 | 7.84 | 5.67 | 4.16 | 272 | 282 | 171 |
| 9 | 3.6 | s | 1000 | | | | | 8.97 | | | | | |
| 10 | 1.8 | s | | | | | | overflow | | | | | |
| 11 | 0.72 | s | | | | | | overflow | | | | | |

### Improved Specific Capacity/Energy and Cycle Life

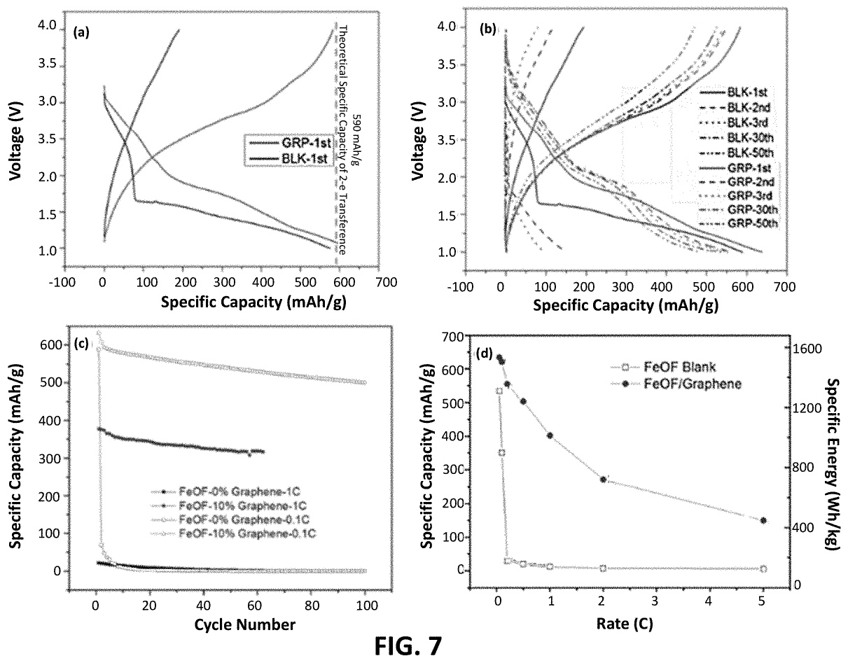

As shown in FIG. 7, the nanostructured FeOF/G with incorporated graphene (also labeled “GRP”) showed superior performance to its blank without graphene (also labeled “BLK”). The FeOF/G achieved 621 mAh/g while FeOF blank only achieved 583 mAh/g (FIG. 7a). More importantly, the FeOF/G has much higher Columbic efficiency at 93.9% than the FeOF blank at 32.9%, suggesting that the incorporation of graphene sheet makes the FeOF conversion reaction more reversible. Notably, the FeOF/G shows tremendous improvement on the cycle life (FIG. 7b). The FeOF/G has a very slow capacity decay rate (0.161%/cycle) and even after 100 cycles, still has 493 mAh/g (78.8% of initial specific capacity and 84.1% of the specific capacity of 3^{rd} cycle), while the FeOF blank immediately dropped to 46 mAh/g (25.0% of initial specific capacity) even after only 4 cycles. It is worthwhile to point out that the decay rates of FeOF/G are almost same for different cycling rate (i.e. 0.1 C and 1 C), indicating that the structure of FeOF nanoparticle in the FeOF/G composite is very stable, which may offer the superfast charging capability (FIG. 7c). Finally, the rate performance is greatly improved, the FeOF/G show 33.51×, 37.66×, and 26.47× improvements over the blank FeOF on 1 C, 2 C, and 5 C, respectively (FIG. 7d). Thus, it has been demonstrated that the performance improvement could be attributed to introduction of graphene which improved the electric conductivity and provide a substrate to stabilize the FeOF particles by morphology observation and structure characterization. The improved cycle life is believed to be the direct result of the incorporation of the graphene sheets, which provide the sites for the anchoring of FeOF nanoparticles, and thus prevent the Fe nanoparticles formed at the end of the discharge from escaping from the matrix of the FeOF.

### Improved (De)lithiation

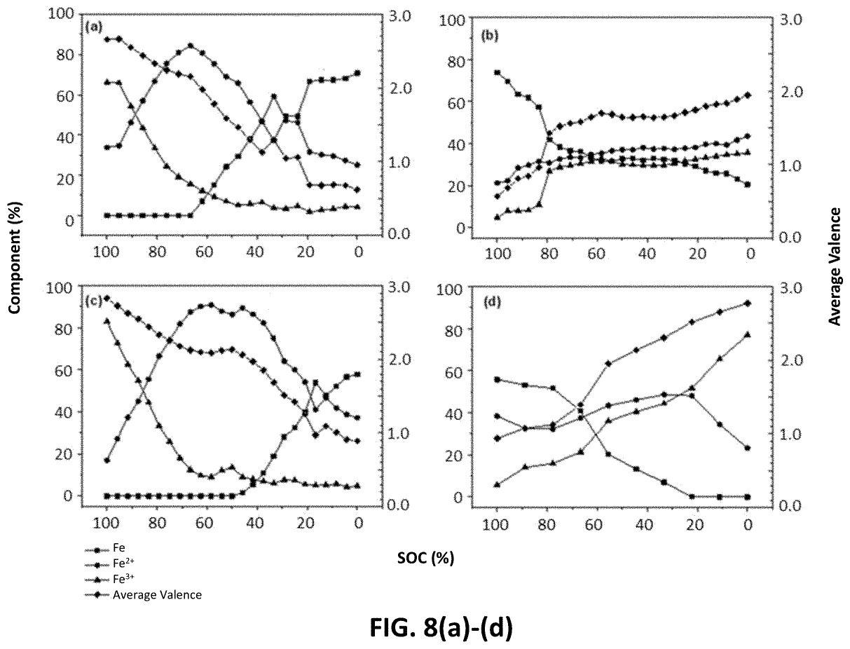

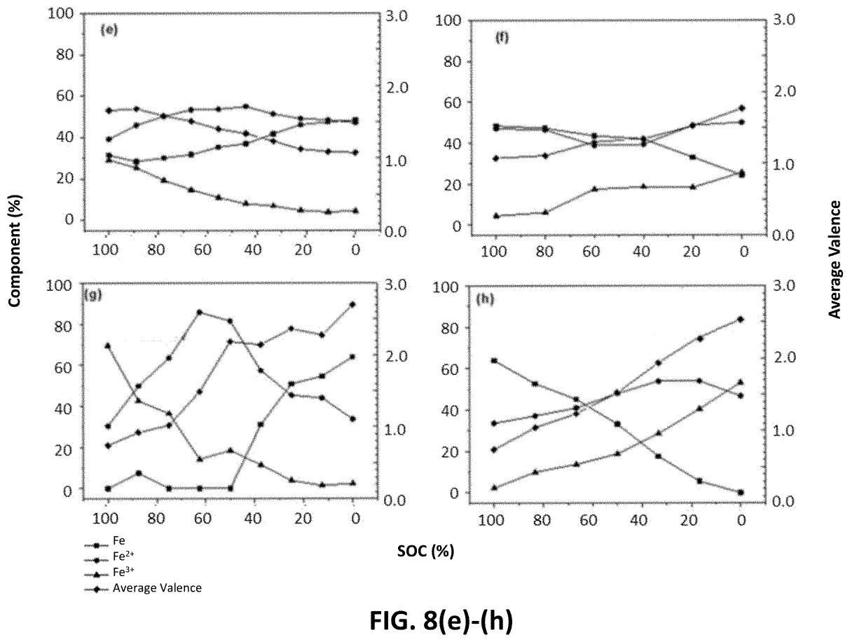

As shown in the XAS spectra of FIG. 8, the existence of graphene sheets was shown to effectively delay the appearance of the metallic Fe in the FeOF/G composite: 55% state of charge (SOC) vs. 35% SOC (FeOF/G vs. FeOF) (FIG. 8a vs. 8c) during lithiation. The metallic Fe slowly decreases in the FeOF/G and disappears at 80% SOC (FIG. 8d) while the metallic Fe decreases but never complete disappears, and maintain a high content in the blank FeOF, 20% during delithiation process (FIG. 8b). The high content of metallic Fe in the blank may indicate that the blank FeOF experiences the irreversible (de)lithiation, which may be resulted from the incomplete reconversion of FeOF, namely, metallic Fe was not transformed back to amphorous rutile FeOF. After 10 cycles, noticeably, there are two significant changes. First, at the delithiated state, no metallic Fe in the FeOF/G but a very high amount of metallic Fe in FeOF blank, i.e. 30%. Second, for the FeOF/G composite, the metallic Fe appears around 50% SOC, increasing to 60% at the end of lithiation (FIG. 8g), then decreasing to almost 0% at the end of delithiation, following the same patterns as that in the 1^{st} cycle (FIG. 8c). However, for the blank FeOF, during the lithiation process, there is much higher Fe content than that in the 1^{st} cycle, 30% at the beginning of lithiation (FIG. 8e). In addition, these metallic Fe increases to almost 50% at the end of lithiation, and then, decreases to about 27% at the end of delithiation, suggesting that quite large of Fe in blank FeOF does not participate in the conversion reaction. These inactive Fe may suggest the loss of Fe from FeOF, which may be responsible for the capacity loss.

### Improved Structure and Morphology

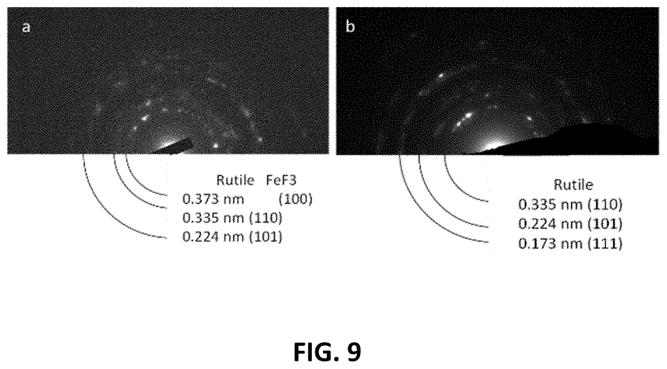

As shown in the TEM diffraction patterns of FIG. 9, both the FeOF blank and the FeOF/G composite appear to be rutile structures with small amounts of FeF₃ initially.

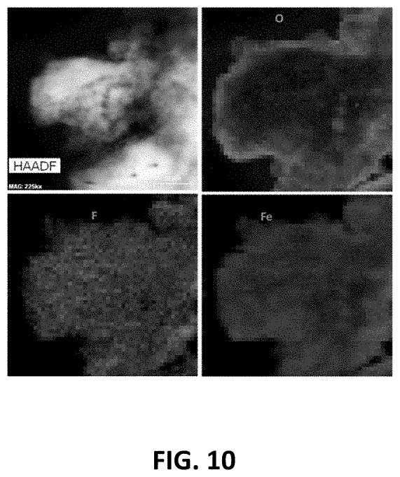

As shown in the EELS images of FIG. 10, after the first lithiaton and delithiation cycle, FeOF particles in the FeOF/G composite (taken out from a coin cell) appear to have a core-shell structure with an O-rich shell.

### III. Stabilized FeOF Using Functionalized Graphenes

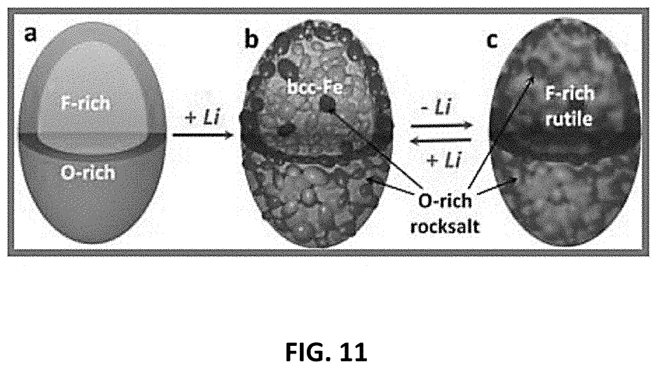

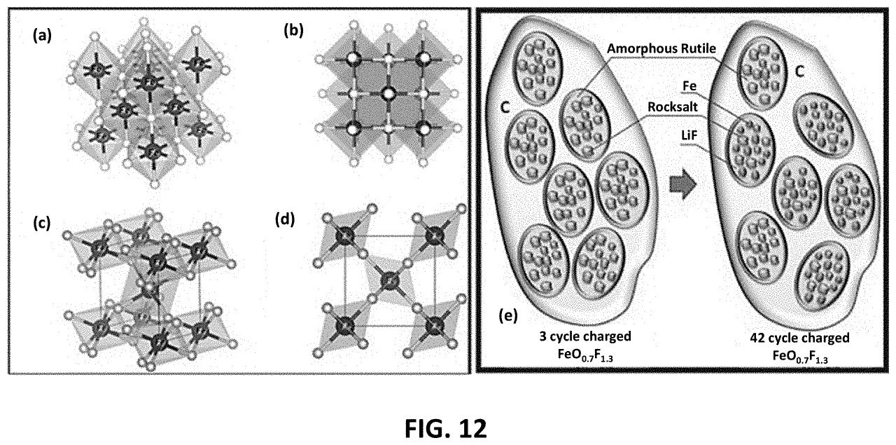

As shown in FIGS. 11 and 12, FeOF is a crystal rutile structure initially and is transformed into a rock salt structure after the first lithiation. Both rutile and rock salt structures are in octahedral arrangement as Fe in the center and O/F on the corners. After the first lithiation/delithiaton cycle, the crystal rutile disappeared and become amorphous rutile. The fully delithiated FeOF has the core-shell structure with F-rich amorphous rutile in the core and O-rich rock salt on the shell while the fully lithiated FeOF has the bcc-Fe nanoparticles in the core and O-rich rock salt on the shell. As the FeOF experiences more and more lithiation/delithiation cycles, some of Fe nanoparticles dissolves in the electrolyte due to the Fe-induced catalytic reactions with electrolyte. Hence, the loss of Fe nanoparticles is one of the major causes of the capacity decay.

The present inventors believe that the center Fe in either amorphous rutile or in rock salt octahedral can be stabilized if an additional local electric field is established to affect the ligand field of FeOF. Thus, the FeOF and/or the graphene may be functionalized to affect the ligand field of FeOF and stabilize the FeOF. Suitable functional groups include carboxylate (—COOH), sulfonate (—SO₃H), hydroxyl (—OH), tertiary amine (NR³⁺, wherein R is H, alkyl, aryl), or combinations thereof. Other suitable polymeric functional groups include polyaniline (PANI), polybenzimidazole (PBI), poly(ethylene oxide) (PEO), polyphenylene oxide (PPO), and/or combinations thereof.

In certain embodiments, the functional groups may be covalently grafted onto the surface of the FeOF nanoparticles and/or graphene sheets through a diazonium salt via a diazonium reaction. The diazonium reaction-based functionalization is a simple and cost-effective way to transform the pure graphene sheets into hierarchical and functional materials that can provide the desired properties (i.e. hydrophobicity, Li⁺/e⁻ conductivity, nanoparticle dispersion and local electric field, etc.) and the functionalized graphene sheets for FeOF nanoparticles to anchor. In addition, such a method is easy for large-scale manufacturing.

The cycle life data for different functional groups is shown in Table 4 below. The —COOH functional group had a positive impact on cycle life, whereas the —OH functional group had a negative impact on cycle life, possible due to the stereo effect of the charged groups.

TABLE 4
Cycle life data for different functional groups

| | Initial Capacity | Decay Rate | |
|---|---|---|---|
| Materials | (mAh/g) | (per cycle) | Cycle Life |
| FeOF | 595 | 9.8% | 1 |
| | | (first 10 cycles) | |
| | | 0.996% | |
| | | (first 100 cycles) | |
| FeOF/Graphene | 621 | 0.212% | 92 |
| FeOF/Graphene-COOH | 574 | 0.161% | 124 |
| FeOF/Graphene-OH | 625 | 0.322% | 62 |

### IV. Coated FeOF Particles

Except for the loss of Fe nanoparticles in the fully lithiated FeOF due to the dissolution, the further cycling of FeOF causes the formation of excess LiF, which is insulated and prevents further delithiation, which is another cause of capacity fading. In certain embodiments, an ultra-thin polymer coating or protection layer with good electronic conductivity may be uniformly coated over the surface of a FeOF nanoparticle. An exemplary coating layer is PANI, which is electrically conductive (6.28×10⁻⁹ S/m) and its conductivity can be enhanced by HBr doping, 4.60×10⁻⁵ S/m (4% HBr doping). Other suitable polymeric coatings include PBI, PEO, PPO, and/or mixtures thereof, for example. The graphene sheets may hold the coated FeOF nanoparticles together to protect the FeOF nanoparticles from Fe dissolution and LiF formation, and, consequently, extend the cycle life. The coating may also be transformed into a carbon layer through the pyrolysis to enhance the electric conductivity. In one example, PANI-coated FeOF/G was shown to significantly improve cycle life, such as from 94 cycles (20% loss of initial specific capacity) of FeOF/G to 209 cycles (FeOF-PANI-G), which represents a 122% improvement.

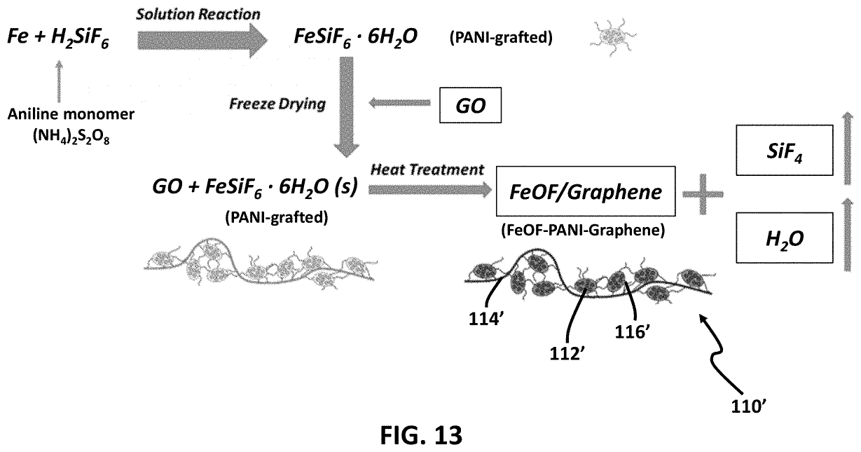

FIG. 13 illustrates an exemplary method for synthesizing a coated FeOF/G composite 110′, including FeOF nanoparticles 112′ with a PANI coating 116′ dispersed over graphene sheets 114′. The method and product of FIG. 13 may be similar to the method and product of FIG. 2 described in Section II above, except that the FeOF precursor may be formed in the presence of a coating monomer. For example, the iron metal powder and the H₂SiF₆ may be combined with an aniline monomer such that the coating is polymerized in situ over the surface of the formed FeSiF₆ nanoparticles. The thickness of the coating may be controlled by the content of the monomer. Other suitable monomers in addition to aniline include pyrrole, thiophenes, thylenedioxythiophene, and/or mixtures thereof, for example.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### EXAMPLES

### 1. Example 1: GO Solution

A GO solution was prepared using a modified Hummer's method. 2 grams of graphite flakes were mixed with 10 mL of concentrated H2SO4, 2 grams of (NH4)2S2O8, and 2 grams of P2O5. The obtained mixture was heated at 80° C. for 4 hours under constant stirring. Then the mixture was filtered and washed thoroughly with DI water. After drying in an oven at 80° C. overnight, this pre-oxidized graphite was then subjected to oxidation using the Hummer's method. 2 grams of pre-oxidized graphite, 1 gram of sodium nitrate and 46 mL of sulfuric acid were mixed and stirred for 15 minutes in an iced bath. Then, 6 grams of potassium permanganate was slowly added to the obtained suspension solution for another 15 minutes. After that, 92 mL DI water was slowly added to the suspension, while the temperature was kept constant at about 98° C. for 15 minutes. After the suspension has been diluted by 280 mL DI water, 10 mL of 30% H2O2 was added to reduce the unreacted permanganate. Finally, the resulted suspension was centrifuged several times to remove the unreacted acids and salts. The purified GO were dispersed in DI water to form a 0.2 mg/mL solution by sonication for 1 hour. Then the GO dispersion was subjected to another centrifugation in order remove the un-exfoliated GO. The resulted GO dilute solution could remain in a very stable suspension without any precipitation for a few months.

### 2. Example 2: FeOF and FeOF/G Cathodes

Two FeSiF₆.6H₂O solutions were heated to 120° C. and then to 200° C. under oxygen gas flow. To one sample, a dilute GO solution was added and further processed to form FeOF particles with 10 wt. % graphene. The resulting blank FeOF and FeOF/G materials were assembled as cathodes in coin cells using Li metal anodes and dielectric separators with electrolytes including 1.0 M LiPF₆ in a 3:7 by weight solvent mixture of EC and EMC for electrochemical testing. The cathodes were paired with different anodes: (a) Li metal, (b) lithiated graphite, and (c) lithiatied LTO.

The cells were evaluated for their whole cell performance, and the results are presented in FIG. 6, Table 3 above, and Table 5 below. All of these cells could be charged to up to 500 C with high specific capacity/energy. However, the specific capacity/energy of the FeOF/G composite and the whole cells is significantly different for these cells due to the different anodes. The charging voltages of the whole cells increased with charging rates. The charge/discharge curves were in the order of (a) Li>(b) graphite>(c) LTO.

For the FeOF/G-Li cell (a), the extremely high charge voltage, almost 8 V at the end-of-charge, is likely caused by the increased SEI formation over the Li metal surface. Although the end-of-charge voltage of the FeOF/G-Li cell is only 4.27 V at a 6 C rate, its charging voltage increased with cycle number, severely limiting the cycle life of such a cell.

For the FeOF/G-LTO cell (c), the lowest charging voltages at different rates were achieved among the three whole cells. However, its cell discharge voltage was too low due to the high potential of LTO, 1.5 V (vs. Li/Li⁺) leading to the low specific capacity/energy of the whole cell.

For the FeOF/G-Graphite cell (b), reasonable end-of-charge voltages were achieved, specifically 4.0 V at a 6 C charge and 5.6 V at 500 C with specific energy of 476 Wh/kg and 215 Wh/kg, respectively. Thus, the FeOF/G-Graphite cell (b) is an exemplary candidate for a superfast charging system. The FeOF/G/Graphite cell (b) also shows a moderate cycle life, even without any coatings or a high voltage electrolyte.

TABLE 5
Summary of whole cell performance

| | Specific | Specific | Specific | |
|---|---|---|---|---|
| | Capacity | Energy of FeOF | Energy of Cell | Cycle |
| Cell | (mAh/g) | (Wh/kg) | (Wh/kg) | Life |
| (a) FeOF/G-Li | 490 | 1086 | 603 | 32 |
| (b) FeOF/G-Graphite | 478 | 1047 | 476 | 49 |
| (c) FeOF/G-LTO | 382 | 563 | 233 | 87 |

### 3. Example 3: High Voltage Electrolyte Performance

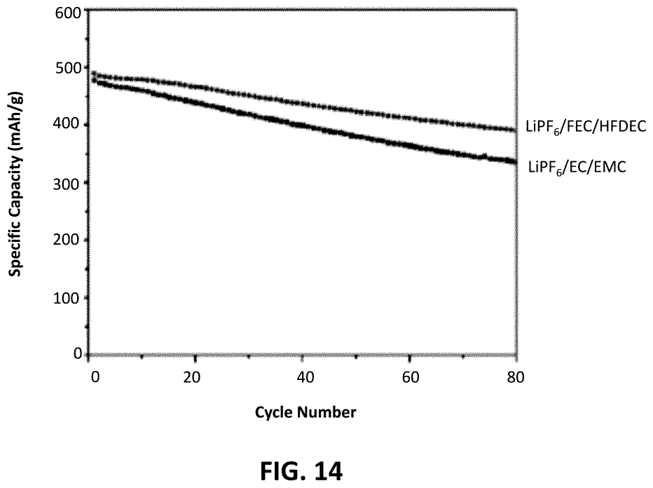

An electrolyte system comprising 1.2 M LiPF₆ in fluoroethylene carbonate (FEC)/bis(2,2,2-trifluoroethyl) carbonate (HFDEC) was evaluated in the FeOF/G-Graphite cell. As shown in FIG. 14, the cycle life was extended from 49 cycles (See Table 5) to 78 cycles, a 47% increase.

What is claimed is:

1. A lithium ion cell comprising:
a cathode comprising a graphene-incorporated iron oxyfluoride composite (FeOF/G); and
an anode;
wherein the cell has a specific energy of at least 180 Wh/kg under a charge rate of at least 6 C.

2. The cell of claim 1, wherein the cell has a charging time of 10 minutes or less.

3. The cell of claim 1, wherein the cell has a specific energy of at least 180 Wh/kg under a charge rate of at least 100 C.

4. The cell of claim 3, wherein the cell has a charging time of 1 minute or less.

5. The cell of claim 1, wherein the cell has a specific energy of at least 180 Wh/kg under a charge rate of 500 C.

6. The cell of claim 5, wherein the cell has a charging time of 30 seconds or less.

7. A lithium ion cell comprising:
an electrolyte;
a cathode comprising a graphene-incorporated iron oxyfluoride composite (FeOF/G); and
an anode comprising a lithiated graphite.

8. The cell of claim 7, wherein the electrolyte comprises a solvent having an electrochemical window of at least 6.0 V.

9. The cell of claim 7, wherein the FeOF/G composite comprises a plurality of graphene sheets and FeOF nanoparticles distributed over the graphene sheets.

10. The cell of claim 7, wherein the cell has a charge rate of at least 6 C.

11. The cell of claim 10, wherein the charge rate is at least 50 C.

12. The cell of claim 7, wherein the FeOF/G composite comprises a plurality of graphene sheets and FeOF nanoparticles positioned between adjacent graphene sheets.

13. The cell of claim 7, wherein the cell has a cycle life of at least 500 cycles.

14. The cell of claim 7, wherein the cell has a specific energy of at least 180 Wh/kg.

15. A cathode comprising:
at least one graphene sheet; and
a layer of iron oxyfluoride (FeOF) nanoparticles evenly distributed over the graphene sheet to define a composite material.

16. The cathode of claim 15, wherein the at least one graphene sheet is at least two parallel graphene sheets, the layer of FeOF nanoparticles being positioned between the at least two parallel graphene sheets.

17. The cathode of claim 15, wherein the at least one graphene sheet is functionalized to adhere the FeOF nanoparticles thereto.

18. The cathode of claim 15, wherein with a charging rate of 6 C and a discharging rate of 0.2 C, the cathode has a specific capacity from 300 to 600 mAh/g.

19. The cathode of claim 18, wherein the specific capacity is 491 mAh/g when the charging rate is 6 C.

20. The cathode of claim 18, wherein the specific capacity is 309 mAh/g when the charging rate is 500 C.
